(19) United States
(12) Patent Application Publication
(10) Pub. No.: US 2017/0290067 A1
(43) Pub. Date: Oct. 5, 2017

(54) APPARATUS, SYSTEM AND METHOD OF ESTABLISHING A SESSION

(71) Applicant: INTEL IP CORPORATION, Santa Clara, CA (US)

(72) Inventors: Daniel Cohn, Raanana (IL); Solomon B. Trainin, Haifa (IL); Ron Eyal, Herzlia (IL)

(21) Appl. No.: 15/083,581

(22) Filed: Mar. 29, 2016

(51) Int. Cl. H04W 76/02; H04L 5/00; H04L 29/08; H04W 52/02

(52) U.S. Cl. CPC H04W 76/02; H04W 52/0209; H04L 5/0055; H04L 69/324

(57) ABSTRACT

Some demonstrative embodiments include apparatuses, systems and/or methods of establishing a session. For example, an apparatus may include circuitry and logic configured to cause a first wireless station to transmit a first message to a second wireless station after establishing a Media Access Control (MAC) connection with the second wireless station, the first message comprising an indication of a first time period; to process a second message from the second wireless station, the second message comprising an indication of a second time period; to determine a selected time period based on the first and second time periods; and to wait for the selected time period prior to attempting to establish a session with the second wireless station.

### TECHNICAL FIELD

Embodiments described herein generally relate to establishing a session.

### BACKGROUND

Some wireless link applications, e.g., wireless video services, may require a minimum link capacity to operate.

A session between a service provider, e.g., a wireless video service, and a user of the service may not be established, for example, if a capacity of a wireless link between the service provider and the user may not be enough to provide an acceptable quality of the service to the user.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic sequence diagram of operations to establish a session between a first device and second device, in accordance with some demonstrative embodiments.

FIG. 3 is a schematic sequence diagram of operations to establish a session between a first device and second device, in accordance with some demonstrative embodiments.

FIG. 4 is a schematic state diagram of a first device to establish a session with a second device, in accordance with some demonstrative embodiments.

FIG. 5 is a schematic flow-chart illustration of a method of establishing a session, in accordance with some demonstrative embodiments.

FIG. 6 is a schematic illustration of an information element (IE), in accordance with some demonstrative embodiments.

FIG. 7 is a schematic flow-chart illustration of a method of establishing a session, in accordance with some demonstrative embodiments.

FIG. 8 is a schematic illustration of a product, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc, indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc, to describe a common object, merely indicate that different instances of like objects are being referred to, and are not intended to imply that the objects so described must be in a given sequence, either temporally, spatially, in ranking, or in any other manner

Some embodiments may be used in conjunction with devices and/or networks operating in accordance with existing WiFi Alliance (WFA) Peer-to-Peer (P2P) specifications (including WiFi P2P technical specification, version 1.5, Aug. 4, 2014) and/or future versions and/or derivatives thereof, devices and/or networks operating in accordance with existing WFA Specifications (including Wi-Fi Neighbor Awareness Networking (NAN) Technical Specification, Version 1.0, May 1, 2015) and/or future versions and/or derivatives thereof, devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11ac-2013 (“IEEE P802.11ac-2013, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 4: Enhancements for Very High Throughput for Operation in Bands below 6 GHz”, December, 2013); IEEE 802.11ad (“IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band”, 28, Dec. 2012); and/or IEEE-802.11REVmc (“IEEE 802.11-REVmc™/D3.0, June 2014 draft standard for Information technology—Telecommunications and information exchange between systems Local and metropolitan area networks Specific requirements; Part 11: Wireless LAN Medium Access Control (MAC) and Physical Layer (PHY) Specification”)) and/or future versions and/or derivatives thereof, devices and/or networks operating in accordance with existing cellular specifications and/or protocols, e.g., 3rd Generation Partnership Project (3GPP), 3GPP Long Term Evolution (LTE) and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some embodiments may be used in conjunction with one or more types of wireless communication signals and/or systems, for example, Radio Frequency (RF), Infra Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), Global System for Mobile communication (GSM), 2G, 2.5G, 3G, 3.5G, 4G, Fifth Generation (5G) mobile networks, 3GPP, Long Term Evolution (LTE), LTE advanced, Enhanced Data rates for GSM Evolution (EDGE), or the like. Other embodiments may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN, e.g., a WiFi network. Other embodiments may be used in conjunction with any other suitable wireless communication network, for example, a wireless area network, a “piconet”, a WPAN, a WVAN and the like.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The phrase “peer to peer (PTP) communication”, as used herein, may relate to device-to-device communication over a wireless link (“peer-to-peer link”) between devices. The PTP communication may include, for example, a WiFi Direct (WFD) communication, e.g., a WFD Peer to Peer (P2P) communication, wireless communication over a direct link within a QoS basic service set (BSS), a tunneled direct-link setup (TDLS) link, a STA-to-STA communication in an independent basic service set (IBSS), or the like.

Some demonstrative embodiments may be used in conjunction with a wireless communication network communicating over a frequency band of 2.4 or 5 Gigahertz (GHz). However, other embodiments may be implemented utilizing any other suitable wireless communication frequency bands, for example, a 60 GHz band, a millimeterWave (mmWave) frequency band, a Sub 1 GHz (S1G) frequency band, a WLAN frequency band, a WPAN frequency band, and the like.

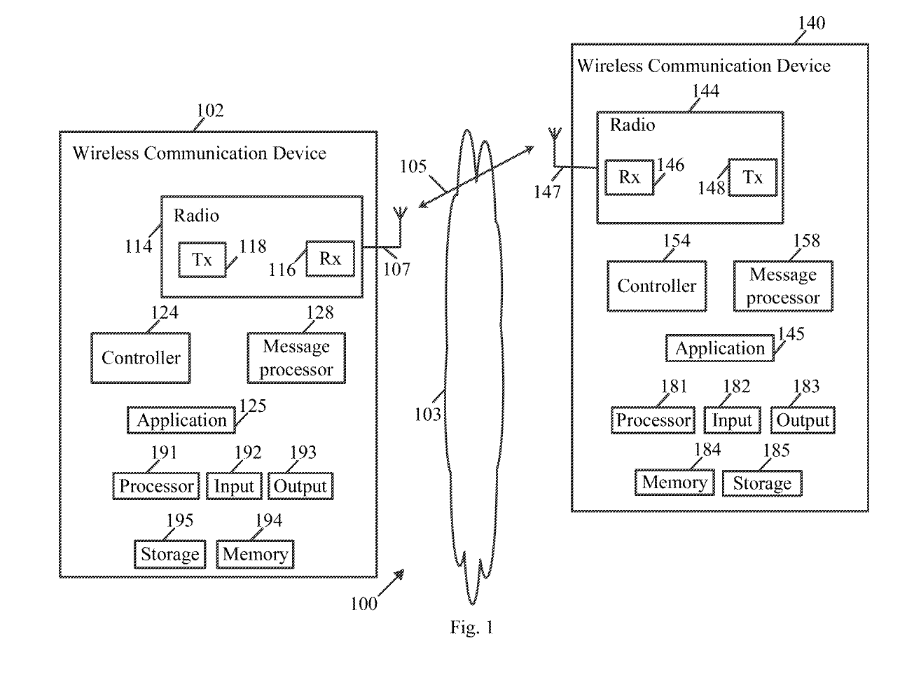

Reference is now made to FIG. 1, which schematically illustrates a block diagram of a system 100, in accordance with some demonstrative embodiments.

As shown in FIG. 1, in some demonstrative embodiments system 100 may include a wireless communication network including one or more wireless communication devices, e.g., wireless communication devices 102 and/or 140.

In some demonstrative embodiments, wireless communication devices 102 and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, a handheld device, an Internet of Things (IoT) device, a sensor device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative embodiments, devices 102 and/or 140 may include, operate as, and/or perform the functionality of one or more STAs. For example, device 102 may include at least one STA, and/or device 140 may include at least one STA.

In some demonstrative embodiments, devices 102 and/or 140 may include, operate as, and/or perform the functionality of one or more WLAN STAs.

In some demonstrative embodiments, devices 102 and/or 140 may include, operate as, and/or perform the functionality of one or more Wi-Fi STAs.

In some demonstrative embodiments, devices 102 and/or 140 may include, operate as, and/or perform the functionality of one or more BT devices.

In some demonstrative embodiments, devices 102 and/or 140 may include, operate as, and/or perform the functionality of one or more Neighbor Awareness Networking (NAN) STAs.

In some demonstrative embodiments, devices 102 and/or 140 may include, operate as, and/or perform the functionality of one or more location measurement STAs.

In one example, a station (STA) may include a logical entity that is a singly addressable instance of a medium access control (MAC) and physical layer (PHY) interface to the wireless medium (WM). The STA may perform any other additional or alternative functionality.

In some demonstrative embodiments, devices 102 and/or 140 may include, operate as, and/or perform the functionality of any other devices and/or STAs.

In some demonstrative embodiments, devices 102 and/or 140 may be configured to operate as, and/or to perform the functionality of, an access point (AP) STA.

In some demonstrative embodiments, devices 102 and/or 140 may be configured to operate as, and/or to perform the functionality of, a non-AP STA.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In one example, device 102 may be configured to operate as, and/or to perform the functionality of an AP STA, and/or device 140 may be configured to operate as, and/or to perform the functionality of a non-AP STA.

In some demonstrative embodiments, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative embodiments, some or all of the components of one or more of devices 102 and/or 140 may be enclosed in a common housing or packaging, and may be interconnected or operably associated using one or more wired or wireless links. In other embodiments, components of one or more of devices 102 and/or 140 may be distributed among multiple or separate devices.

In some demonstrative embodiments, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 executes instructions, for example, of an Operating System (OS) of device 102 and/or of one or more suitable applications. Processor 181 executes instructions, for example, of an Operating System (OS) of device 140 and/or of one or more suitable applications.

In some demonstrative embodiments, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 includes, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative embodiments, memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 includes, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative embodiments, wireless communication devices 102 and/or 140 may be capable of communicating content, data, information and/or signals via a wireless medium (WM) 103. In some demonstrative embodiments, wireless medium 103 may include, for example, a radio channel, a cellular channel, a Global Navigation Satellite System (GNSS) Channel, an RF channel, a WiFi channel, an IR channel, a Bluetooth (BT) channel, and the like.

In some demonstrative embodiments, wireless communication medium 103 may include a wireless communication channel over a 2.4 Gigahertz (GHz) frequency band, a 5 GHz frequency band, a millimeterWave (mmWave) frequency band, e.g., a 60 GHz frequency band, a Sub 1 Gigahertz (S1G) band, and/or any other frequency band.

In some demonstrative embodiments, devices 102 and/or 140 may include one or more radios including circuitry and/or logic to perform wireless communication between devices 102, 140 and/or one or more other wireless communication devices. For example, device 102 may include a radio 114, and/or device 140 may include a radio 144.

In some demonstrative embodiments, radios 114 and/or 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at lest one receiver 146.

In some demonstrative embodiments, radios 114 and/or 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative embodiments, radio 114 and/or radio 144, transmitters 118 and/or 148, and/or receivers 116 and/or 148 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative embodiments, radios 114 and/or 144 may be configured to communicate over a 2.4 GHz band, a 5 GHz band, an mmWave band, a S1G band, and/or any other band.

In some demonstrative embodiments, radios 114 and/or 144 may include, or may be associated with, one or more antennas 107 and/or 147, respectively.

In one example, device 102 may include a single antenna 107. In another example, device 102 may include two or more antennas 107.

In one example, device 140 may include a single antenna 147. In another example, device 140 may include two or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a phased array antenna, a multiple element antenna, a set of switched beam antennas, and/or the like. In some embodiments, antennas 107 and/or 147 may implement transmit and receive functionalities using separate transmit and receive antenna elements. In some embodiments, antennas 107 and/or 147 may implement transmit and receive functionalities using common and/or integrated transmit/receive elements.

In some demonstrative embodiments, wireless communication devices 102 and/or 140 may form, and/or may communicate as part of, a wireless local area network (WLAN).

In some demonstrative embodiments, wireless communication devices 102 and/or 140 may form, and/or may communicate as part of, a WiFi network.

In some demonstrative embodiments, wireless communication devices 102 and/or 140 may form, and/or may communicate as part of, a WiFi Direct (WFD) network, e.g., a WiFi direct services (WFDS) network, and/or may perform the functionality of one or more WFD devices.

In one example, wireless communication devices 102 and/or 140 may include, or may perform the functionality of a WiFi Direct device.

In some demonstrative embodiments, wireless communication medium 103 may include a direct link, for example, a PTP link, e.g., a WiFi direct P2P link or any other PTP link, for example, to enable direct communication between wireless communication devices 102 and/or 140.

In some demonstrative embodiments, wireless communication devices 102 and/or 140 may perform the functionality of WFD P2P devices. For example, devices 102 and/or 140 may be able to perform the functionality of a P2P client device, and/or P2P group Owner (GO) device.

In other embodiments, wireless communication devices 102 and/or 140 may form, and/or communicate as part of, any other network, and/or may perform the functionality of any other wireless devices or stations.

In some demonstrative embodiments, devices 102 and/or 140 may include one or more applications configured to provide, share, and/or to use one or more services, e.g., a social application, a file sharing application, a media application and/or the like.

In some demonstrative embodiments, device 102 may execute an application 125. In some demonstrative embodiments, device 140 may execute an application 145.

In some demonstrative embodiments, devices 102 and/or 140 may be capable of sharing, showing, sending, transferring, printing, outputting, providing, synchronizing, and/or exchanging content, data, and/or information, e.g., between applications and/or services of devices 102 and/or 140 and/or one or more other devices.

In some demonstrative embodiments, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative embodiments, controllers 124 and/or 154 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein.

In some demonstrative embodiments, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In some demonstrative embodiments, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In some demonstrative embodiments, message processors 128 and/or 158 may include circuitry and/or logic, e.g., one or more processors including circuitry and/or logic, memory circuitry and/or logic, Media-Access Control (MAC) circuitry and/or logic, Physical Layer (PHY) circuitry and/or logic, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative embodiments, at least part of the functionality of message processor 128 may be implemented as part of radio 114, and/or at least part of the functionality of message processor 158 may be implemented as part of radio 144.

In some demonstrative embodiments, at least part of the functionality of message processor 128 may be implemented as part of controller 124, and/or at least part of the functionality of message processor 158 may be implemented as part of controller 154.

In other embodiments, the functionality of message processor 128 may be implemented as part of any other element of device 102, and/or the functionality of message processor 158 may be implemented as part of any other element of device 140.

In some demonstrative embodiments, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other embodiments, controller 124, message processor 128 and/or radio 114 may be implemented by one or more additional or alternative elements of device 102.

In some demonstrative embodiments, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other embodiments, controller 154, message processor 158 and/or radio 144 may be implemented by one or more additional or alternative elements of device 140.

In some demonstrative embodiments, devices 102 and 140 may establish a Media Access Control (MAC) connection 105 between devices 102 and 140.

In some demonstrative embodiments, controller 124 may be configured to control, cause and/or trigger device 102 to establish the MAC connection 105 with device 140.

In some demonstrative embodiments, controller 154 may be configured to control, cause and/or trigger device 140 to establish the MAC connection 105 with device 102.

In some demonstrative embodiments, devices 102 and 140 may establish the MAC connection 105 between devices 102 and 140, for example, prior to establishing a session between devices 102 and 140, e.g., to share, provide, and/or mange one or more services and/or applications between devices 102 and 140.

In one example, device 102 may include a Smartphone, and device 140 may include a wireless display, e.g., a wireless docking display. According to this example, devices 102 and 140 may establish the session between devices 102 and 140, for example, to provide wireless video services between devices 102 and 140, e.g., to wirelessly stream video from the Smartphone to the wireless display.

In some demonstrative embodiments, the session between devices 102 and 140 may require a minimum link capacity of a wireless link between devices 102 and 140 to operate.

In some demonstrative embodiments, devices 102 and 140 may not establish the session between devices 102 and 140, for example, until it can be determined and/or guaranteed that the link capacity of the wireless link may be sufficient to provide an acceptable quality of service over the session between devices 102 and 140.

In some demonstrative embodiments, devices 102 and 140 may attempt to establish the session between devices 102 and 140 by performing an admission control procedure to determine if the link capacity of the wireless link between devices 102 and 140 is greater than a predefined threshold.

In one example, the admission control procedure may include a process to be performed by a device, e.g., device 102 and/or device 140, for example, to assure that the wireless link capacity of the wireless link between devices 102 and 140 may be enough to provide the acceptable quality of service.

In some demonstrative embodiments, continuously monitoring the wireless link capacity, for example, when the wireless link capacity is below an acceptable quality of service, for example, to determine when the wireless link capacity is enough to provide the acceptable quality of service, may involve multiple PHY and MAC processes, e.g., transmission and reception of packets, beamforming direction search, and/or frequency channel switches, which may increase a power consumption of a mobile device monitoring the wireless link capacity, and/or may result in a significant battery drain of the mobile device.

In some demonstrative embodiments, continuously monitoring the wireless link capacity, e.g., by a mobile device, may be performed by a plurality of session establishment attempts, for example, until the he wireless link capacity may be enough to provide the acceptable quality of service.

Some demonstrative embodiments may introduce a waiting period between session establishment attempts, during which devices 102 and/or 140 may be allowed to go to a power save mode, for example, between the session establishment attempts, e.g., as described below.

In some demonstrative embodiments, upon a failed attempt to establish a session between devices 102 and 140, devices 102 and 140 may negotiate a later rendezvous time to retry establishing the session, for example, if devices 102 and 140 are battery-powered, e.g., as described below.

In some demonstrative embodiments, the later rendezvous time may be negotiated, for example, based on power supply and/or session establishment time requirements of devices 102 and/or 140, e.g., as described below.

In one example, if one device is a battery-powered device and the other device is a mains-powered device, upon a failed attempt to establish a session the two devices may either negotiate a later rendezvous time, e.g., as described above, or the two devices may agree that the mains-powered device may remain in a ready state and the battery-powered device may retry establishing a session at any later time. For example, the battery-powered device may attempt to reestablish the session at an end of a waiting period determined by the battery-powered device, or in response to an external trigger, for example, a user request or motion detection.

In some demonstrative embodiments, devices 102 and/or 140 may be configured to verify whether a link capacity of a wireless link between devices 102 and 140 is sufficient to initiate a session, e.g., after establishing MAC connection 105.

In some demonstrative embodiments, a device of devices 102 and 140, e.g., device 102, may initiate a negotiation of the later rendezvous time.

In some demonstrative embodiments, a GO of a group including devices 102 and 140, e.g., device 102, may initiate the negotiation of the later rendezvous time. In other embodiments, any other mechanism may be used to select a device to initiate the negotiation of the later rendezvous time.

In some demonstrative embodiments, device 102 may transmit a first message to device 140, e.g., after establishing MAC connection 105, for example, to initiate the negotiation of the later rendezvous time.

In some demonstrative embodiments, controller 124 may be configured to control, cause and/or trigger device 102 to transmit the first message.

In one example, controller 124 may be configured to control, cause and/or trigger transmitter 118 to transmit the first message, and/or message processor 128 to generate the first message.

In some demonstrative embodiments, the first message may include an indication of a first time period.

In some demonstrative embodiments, the first message may include an information element (IE), e.g., an admission IE, including a power field and a time field.

In some demonstrative embodiments, the power field may indicate a power source of device 102.

In some demonstrative embodiments, the power field may indicate if device 102 is battery-powered or powered by a mains power source.

In some demonstrative embodiments, the time field may include the indication of the first time period.

In some demonstrative embodiments, the information element may also include an admission field configured to indicate whether or not an admission control procedure to establish the session is successful.

In some demonstrative embodiments, controller 124 may be configured to control, cause and/or trigger device 102 to transmit the first message, for example, upon failure of an attempt to establish the session with device 140.

In some demonstrative embodiments, device 102 may transmit the first message, for example, to negotiate the later rendezvous time, e.g., after the failure of the attempt to establish the session with device 140.

In some demonstrative embodiments, device 140 may receive the first message including the indication of the first time period, the indication of the power source of device 102, and the indication that the attempt to establish the session with device 140 failed.

In some demonstrative embodiments, controller 154 may be configured to control, cause and/or trigger device 140 to process the first message including the indication of the first time period, the power source of device 102, and the indication that the attempt to establish the session with device failed.

In one example, controller 154 may be configured to control, cause and/or trigger receiver 116 to receive the first message, and/or message processor 158 to process, access and/or decode the first message.

In some demonstrative embodiments, device 140 may transmit a second message to device 102, for example, in response to the first message.

In some demonstrative embodiments, controller 154 may be configured to control, cause and/or trigger device 140 to transmit the second message.

In one example, controller 154 may be configured to control, cause and/or trigger transmitter 148 to transmit the second message, and/or message processor 158 to generate the second message.

In some demonstrative embodiments, the second message may include an indication of a second time period.

In some demonstrative embodiments, the second message may include the information element (IE) including the power field and the time field.

In some demonstrative embodiments, the first and second messages may include Peer-to-Peer (P2P) messages. In some demonstrative embodiments, one of the first and second messages may include an information request, e.g., a P2P information request, and another one of the first and second messages may include an information response, e.g., a P2P information request.

In some demonstrative embodiments, one of the first and second messages may include an association request, e.g., a P2P association request, and another one of the first and second messages may include an association response, e.g., a P2P association request.

In some demonstrative embodiments, one of the first and second messages may include a re-association request, e.g., a P2P re-association request, and another one of the first and second messages may include a re-association response, e.g., a P2P re-association request.

In other embodiments, the first and second messages may include any other type of messages.

In some demonstrative embodiments, device 140 may be configured to set the power field in the second message to indicate a power source of device 140.

In some demonstrative embodiments, device 140 may be configured to set the power field in the second message to indicate if device 140 is battery-powered or powered by a mains power source.

In some demonstrative embodiments, device 140 may be configured to set the time field in the second message to include the indication of the second time period.

In some demonstrative embodiments, the first time period and/or the second time period may be determined and/or configured, for example, as part of a device configuration, e.g., according to power consumption of the device, responsiveness requirements of the device, and/or one or more additional or alternative parameters and/or criteria.

In some demonstrative embodiments, the admission IE may also include the admission field configured to indicate whether or not an admission control procedure to establish the session is successful.

In some demonstrative embodiments, a content of the admission field may be set to a value indicating “passed”, for example, if the link capacity has been estimated to be above the threshold to establish a session between devices 102 and 140, or to a value indicating “failed” otherwise.

In some demonstrative embodiments, device 102 may receive the second message including the indication of the second time period, the indication of the power source of device 140, and the indication that the attempt to establish the session with device 102 failed.

In some demonstrative embodiments, controller 124 may be configured to control, cause and/or trigger device 102 to transmit to device 140 an acknowledge (Ack) message to confirm receipt of the second message, for example, upon receipt of the second message.

In some demonstrative embodiments, controller 124 may be configured to control, cause and/or trigger device 102 to process the second message from device 140 including the indication of the second time period, the indication of the power source of device 140, and the indication that the attempt to establish the session with device 102 failed.

In one example, controller 124 may be configured to control, cause and/or trigger receiver 116 to receive the second message, and/or message processor 128 to process, access and/or decode the second message.

In some demonstrative embodiments, controller 124 may be configured to control, cause and/or trigger device 102 to determine a selected time period based on the first and second time periods.

In some demonstrative embodiments, controller 124 may be configured to control, cause and/or trigger device 102 to determine the selected time period to include a longest period of the first and second time periods.

In one example, device 102 may determine the selected time period to include the longest period of the first and second time periods, for example, if device 102 is battery-powered, and the second message indicates that device 140 is battery powered.

In some demonstrative embodiments, controller 124 may be configured to control, cause and/or trigger device 102 to determine the selected time period to include the second time period, for example, if device 102 is powered by a mains power source, and the second message indicates that device 140 is battery-powered.

In some demonstrative embodiments, controller 124 may be configured to control, cause and/or trigger device 102 to determine the selected time period to include the first time period, for example, if the second message indicates device 140 powered by a mains power source, and device 102 is battery powered.

In some demonstrative embodiments, controller 154 may be configured to control, cause and/or trigger device 140 to determine the selected time period to include a longest period of the first and second time periods.

In one example, device 140 may determine the selected time period to include the longest period of the first and second time periods, for example, if device 140 is battery-powered, and the first message indicates that device 102 is battery-powered.

In some demonstrative embodiments, controller 154 may be configured to control, cause and/or trigger device 140 to determine the selected time period to include the second time period, for example, if the first message indicates that device 102 is powered by a mains power source, and device 140 is battery-powered.

In some demonstrative embodiments, controller 154 may be configured to control, cause and/or trigger device 140 to determine the selected time period to include the first time period, for example, if the first message indicates that device 102 is battery powered, and device 140 powered by a mains power source.

In some demonstrative embodiments, controller 124 may be configured to control, cause and/or trigger device 102 to wait for a duration of the selected time period, for example, prior to attempting to establish a session with device 140.

In some demonstrative embodiments, controller 154 may be configured to control, cause and/or trigger device 140 to wait for a duration of the selected time period, for example, prior to attempting to establish a session with device 102.

In some demonstrative embodiments, devices 102 and 140 may attempt to establish the session, e.g., by performing the admission control procedure, for example, after the selected time period elapsed.

In some demonstrative embodiments, the session between devices 102 and 140 may be established, for example, if the admission control procedure is successful.

In some demonstrative embodiments, device 102 and device 140 may include battery-powered devices.

In some demonstrative embodiments, controller 124 may be configured to control, cause and/or trigger device 102 to determine the selected time period, to include the longest time period of the first and second time periods, e.g., the first time period.

In some demonstrative embodiments, controller 124 may be configured to control, cause and/or trigger device 102 to wait for the selected time period prior to attempting to establish a session with device 140.

In some demonstrative embodiments, controller 154 may be configured to control, cause and/or trigger device 140 to wait for the selected time period prior to attempting to establish a session with device 102.

In some demonstrative embodiments, controller 124 may be configured to allow device 102 to be in a power-save mode during the selected time period.

In some demonstrative embodiments, controller 154 may be configured to allow device 140 to be in a power-save mode during the selected time period.

In one example, both devices 102 and 140 may switch to a low-power standby mode, and may operate at an active power mode to retry the admission control procedure, for example, when the selected time period has elapsed. The longest time period of the first and second time periods may be selected, for example, in order to comply with power consumption requirements of both devices 102 and 140, e.g., even at an expense of slower connection time.

In some demonstrative embodiments, a tolerance window may be used, for example, by both devices 102 and 140, e.g., to ensure that both devices 102 and 140 may be available when the selected time period has elapsed, for example, even if a of clock rate difference exists between clocks of devices 102 and 140.

In some demonstrative embodiments, device 102 may include a battery-powered device, and device 140 may be powered by a mains power source.

In some demonstrative embodiments, controller 124 may be configured to control, cause and/or trigger device 102 to determine the selected time period, to include the first time period.

In some demonstrative embodiments, controller 124 may be configured to control, cause and/or trigger device 102 to wait for the first time period prior to attempting to establish a session with device 140.

In some demonstrative embodiments, controller 124 may be configured to allow device 102 to be in a power-save mode during the first time period.

In some demonstrative embodiments, device 140 may remain in an active state and device 102 may retry the admission control procedure, for example, without previous coordination with device 140.

In one example, device 102 may retry the admission control procedure, for example, periodically based on the first time period, or at any other periodicity.

In another example, device 102 may retry the admission control procedure, for example, based on a trigger from a user of device 102 or from application 125.

In some demonstrative embodiments, device 140 may include a battery-powered device, and device 102 may be powered by a mains power source.

In some demonstrative embodiments, controller 124 may be configured to control, cause and/or trigger device 102 to determine the selected time period, to include the second time period.

In some demonstrative embodiments, controller 124 may be configured to control, cause and/or trigger device 102 to wait for the second time period prior to attempting to establish a session with device 140.

In some demonstrative embodiments, controller 124 may be configured to remain at an active power mode during the second time period.

In some demonstrative embodiments, device 140 may retry the admission control procedure, for example, without previous coordination with device 102.

In one example, device 140 may retry the admission control procedure, for example, periodically based on the second time period, or at any other periodicity.

In another example, device 140 may retry the admission control procedure, for example, based on a trigger from a user of device 140 or from application 145.

In some demonstrative embodiments, device 140 may be configured to retry the admission control procedure, for example, even before the second time period has elapsed, e.g., since device 102 remains at the active power mode.

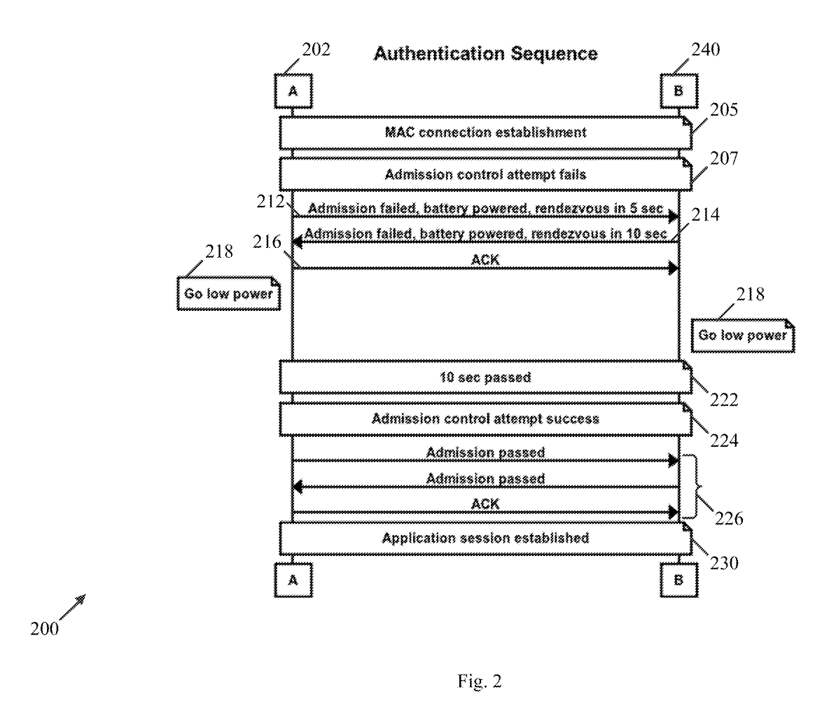

Reference is made to FIG. 2, which schematically illustrates a sequence diagram 200 of operations to establish a session between a first device 202, denoted A, and a second device 240, denoted B, in accordance with some demonstrative embodiments. For example, device 202 may perform the functionality of device 102 (FIG. 1), and/or device 240 may perform the functionality of device 140 (FIG. 1).

In some demonstrative embodiments, device 202 may include a battery-powered device, and device 240 may also include a battery-powered device.

In some demonstrative embodiments, as shown in FIG. 2, devices 202 and 240 may establish a MAC connection 205.

In some demonstrative embodiments, as shown in FIG. 2, devices 202 and 240 may fail to establish a session between devices 202 and 240, for example, by failing an admission control procedure 207.

In some demonstrative embodiments, as shown in FIG. 2, device 202 may transmit a first message 212 to device 240.

In some demonstrative embodiments, as shown in FIG. 2, first message 212 may include an indication of a time period of 5 seconds, an indication that device 202 is battery-powered, and an indication that the admission control procedure 207 failed.

In some demonstrative embodiments, as shown in FIG. 2, device 240 may receive the first message 212 from device 202.

In some demonstrative embodiments, as shown in FIG. 2, device 240 may transmit a second message 214 to device 202, for example, in response to the first message 212 from device 202.

In some demonstrative embodiments, as shown in FIG. 2, second message 214 may include an indication of a time period of 10 seconds, an indication that device 240 is battery-powered, and an indication that the admission control procedure 207 failed.

In some demonstrative embodiments, as shown in FIG. 2, device 202 may receive the second message 214 from device 240.

In some demonstrative embodiments, as shown in FIG. 2, device 202 may transmit to device 240 an Ack message 216 to acknowledge receipt of second message 214.

In some demonstrative embodiments, device 202 and 240 may determine the longest period between 10 and 5 seconds, e.g., 10 seconds, for waiting prior to attempting to establish a session between devices 202 and 240.

In some demonstrative embodiments, as shown in FIG. 2, device 202 and device 240 may be allowed to be in the power save mode 218, for example, during the longest time period, e.g., the period of 10 seconds.

In some demonstrative embodiments, as shown in FIG. 2, upon the longest period of 10 seconds elapsing (222), devices 102 and 140 may attempt to establish the session, for example, by performing an admission control procedure 224.

In some demonstrative embodiments, as shown in FIG. 2, the admission control procedure 224 is successful.

In some demonstrative embodiments, as shown in FIG. 2, devices 202 and 240 may communicate messages 226 indicating the admission control procedure 224 is successful.

In some demonstrative embodiments, as shown in FIG. 2, a session 230 may be established by devices 202 and 240, for example, subsequent to the success of the admission control procedure 224.

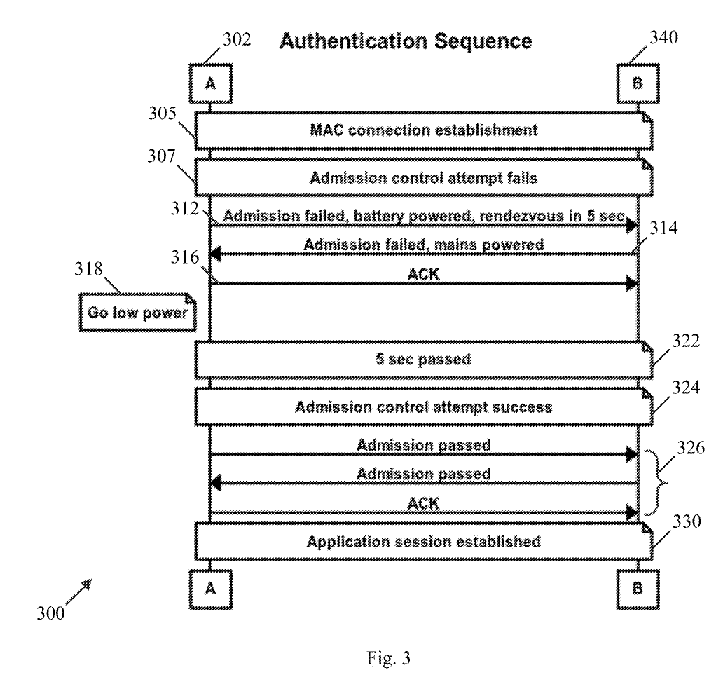

Reference is made to FIG. 3, which schematically illustrates a sequence diagram 300 of operations to establish a session between a first device 302, denoted A, and a second device 340, denoted B, in accordance with some demonstrative embodiments. For example, device 302 may perform the functionality of device 102 (FIG. 1), and/or device 340 may perform the functionality of device 140 (FIG. 1).

In some demonstrative embodiments, device 302 may include a battery-powered device, and device 340 may be powered by a mains power source.

In some demonstrative embodiments, as shown in FIG. 3, devices 302 and 340 may establish a MAC connection 305.

In some demonstrative embodiments, as shown in FIG. 3, devices 302 and 340 may fail to establish a session between devices 302 and 340, for example, by failing an admission control procedure 307.

In some demonstrative embodiments, as shown in FIG. 3, device 302 may transmit a first message 312 to device 340.

In some demonstrative embodiments, as shown in FIG. 3, first message 312 may include an indication of a time period of 5 seconds, an indication that device 302 is battery-powered, and an indication that the admission control procedure 307 failed.

In some demonstrative embodiments, as shown in FIG. 3, device 340 may receive the first message 312 from device 302.

In some demonstrative embodiments, as shown in FIG. 3, device 340 may transmit a second message 314 to device 302, for example, in response to the first message 312 from device 302.

In some demonstrative embodiments, as shown in FIG. 3, second message 314 may include an indication of a time period of 1 seconds, an indication that device 340 is powered by a mains power source, and an indication that the admission control procedure 307 failed.

In some demonstrative embodiments, as shown in FIG. 3, device 302 may receive the second message 314 from device 340.

In some demonstrative embodiments, as shown in FIG. 3, device 302 may transmit to device 340 an Ack message 316 to acknowledge receipt of second message 314.

In some demonstrative embodiments, device 302 may select to wait, e.g., for the period of 5 seconds or any other period, prior to attempting to establish a session between devices 302 and 340, for example, since device 302 is battery-powered, and device 340 is powered by a mains powered source.

In some demonstrative embodiments, as shown in FIG. 3, device 302 may be allowed to be in the power save mode 318, for example, during the time period of 5 seconds.

In some demonstrative embodiments, as shown in FIG. 3, device 340 may remain in an active-mode, for example, during at least the time period of 5 seconds, e.g., since device 340 is powered by a mains powered source

In some demonstrative embodiments, as shown in FIG. 3, upon the time period of 5 seconds elapsing (322), device 302 may attempt to establish the session with device 340, for example, by performing an admission control procedure 324.

In some demonstrative embodiments, as shown in FIG. 3, the admission control procedure 324 is successful.

In some demonstrative embodiments, as shown in FIG. 3, devices 302 and 340 may communicate messages 326 indicating the admission control procedure 324 is successful.

In some demonstrative embodiments, as shown in FIG. 3, a session 330 may be established by devices 302 and 340, for example, subsequent to the success of admission control procedure 324.

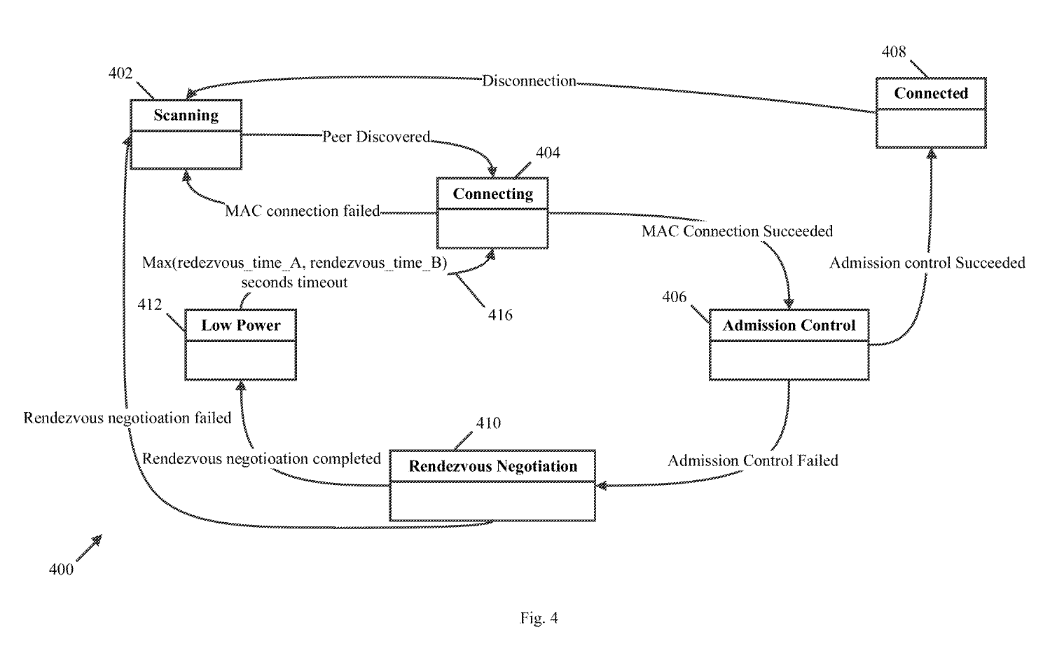

Reference is made to FIG. 4, which schematically illustrates a state diagram 400 of a first device for establishing a session with a second device, in accordance with some demonstrative embodiments. For example, the first device may perform the functionality of device 102 (FIG. 1); and/or the second device may perform the functionality of device 140 (FIG. 1).

In some demonstrative embodiments, at a state 402, the first device may scan for the second device.

In some demonstrative embodiments, at a state 404, the first device may establish a MAC connection with the second device, for example, if the first device discovers the second device.

In some demonstrative embodiments, upon successful establishment of the MAC connection, at a state 406, the first device may attempt to establish a session between the first and the second devices, for example, by performing an admission control procedure, e.g., to determine if a link capacity of a wireless link between the first and second devices is greater than a predefined threshold.

In some demonstrative embodiments, at a state 408, the session between the first device and the second device may be established, for example, if the admission control procedure, e.g., at state 406, is successful.

In some demonstrative embodiments, at a state 410, the first device may negotiate a time period to attempt to establish the session, for example, if the admission control procedure, e.g., at state 406, has failed.

In some demonstrative embodiments, at a state 412, the first device may switch to a power save mode, for example, during the time period determined at state 410.

In some demonstrative embodiments, as indicated by arrow 416, when the time period elapses, the first device may attempt again to establish the session.

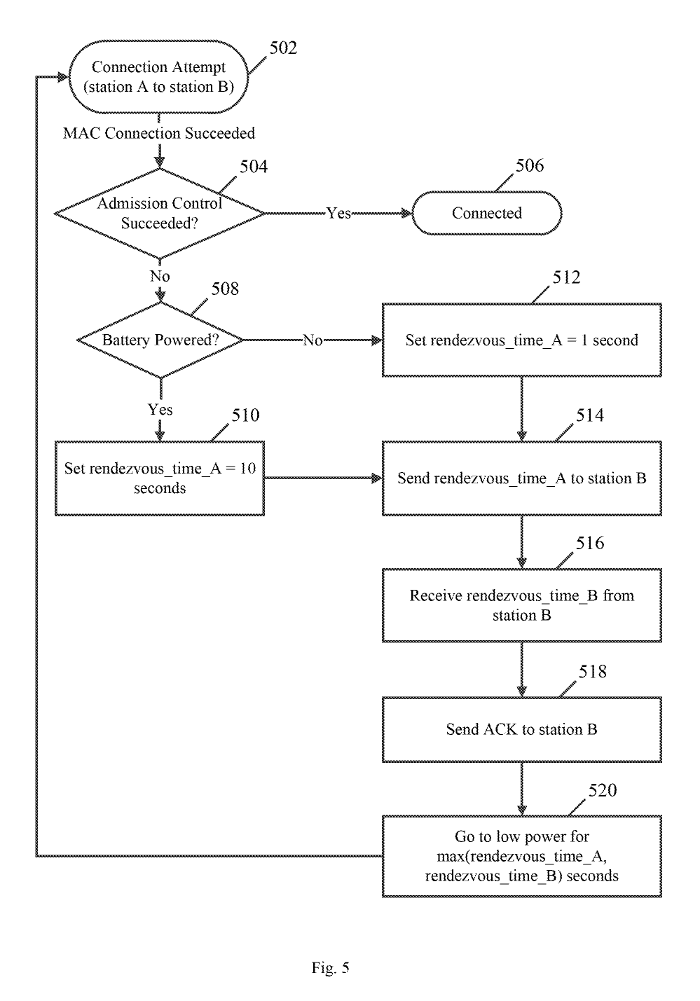

Reference is made to FIG. 5, which schematically illustrates a method of establishing a session, in accordance with some demonstrative embodiments. For example, one or more of the operation of FIG. 5 may be performed by one or more elements of a system, e.g., system 100 (FIG. 1); a device, e.g., wireless communication devices 102 and/or 140 (FIG. 1); a controller, e.g., controller 124 (FIG. 1), and/or controller 154 (FIG. 1); a radio, e.g., radio 114 (FIG. 1), and/or radio 144 (FIG. 1); and/or a message processor, e.g., message processor 128 (FIG. 1) and/or message processor 158 (FIG. 1).

As indicated at block 502, the method may include establishing a MAC connection between a first device and a second device. For example, controller 124 (FIG. 1) may control, cause and/or trigger device 102 (FIG. 1) to establish MAC connection 105 (FIG. 1) between device 140 (FIG. 1) and device 102 (FIG. 1), e.g., as described above.

As indicated at block 504, the method may include attempting to establish a session between the first and second devices by performing an admission control procedure. For example, controller 124 (FIG. 1) may control, cause and/or trigger device 102 (FIG. 1) to attempt to establish a session between devices 102 and 140 (FIG. 1) by performing the admission control procedure, e.g., as described above.

As indicated at block 506, the method may include establishing the session between the first and second devices, for example, if the admission control procedure is successful. For example, controller 124 (FIG. 1) may control, cause and/or trigger device 102 (FIGS. 1) to establish the session between devices 102 and 140 (FIG. 1), for example, if the admission control procedure is successful, e.g., as described above.

As indicated at block 508, the method may include determining if the first device is battery-powered. For example, controller 124 (FIG. 1) may control, cause and/or trigger device 102 (FIG. 1) to determine if device 102 (FIG. 1) is battery powered, e.g., as described above.

As indicated at block 510, the method may include setting a first time period to a first value, e.g., 10 seconds, if the first device is battery-powered. For example, controller 124 (FIG. 1) may control, cause and/or trigger device 102 (FIG. 1) to set the first time period to the first value, if device 102 (FIG. 1) is battery-powered, e.g., as described above.

As indicated at block 512, the method may include setting the first time period to a second value less than the first value, e.g., 1 second, if the first device is powered by a mains power source. For example, controller 124 (FIG. 1) may control, cause and/or trigger device 102 (FIG. 1) to set the first time period to the second value, if device 102 (FIG. 1) is powered by a mains power source, e.g., as described above.

As indicated at block 514, the method may include sending an indication of the first time period to the second device. For example, controller 124 (FIG. 1) may control, cause and/or trigger device 102 (FIG. 1) to send a first message including an indication the first time period to device 140 (FIG. 1), e.g., as described above.

As indicated at block 516, the method may include receiving an indication of a second time period from the second device. For example, controller 124 (FIG. 1) may control, cause and/or trigger device 102 (FIG. 1) to process a second message including an indication the second time period from device 140 (FIG. 1), e.g., as described above.

As indicated at block 518, the method may include sending an Ack message to the second device. For example, controller 124 (FIG. 1) may control, cause and/or trigger device 102 (FIG. 1) to send the Ack message to acknowledge receipt of the second message, e.g., as described above.

As indicated at block 520, the method may include switching to a low power mode for a selected time period including the longest time period of the first and second time periods. For example, controller 124 (FIG. 1) may control, cause and/or trigger device 102 (FIG. 1) to determine the selected time period, based on the first and second time periods, and may allow device 102 (FIG. 1) to be in the power-save mode during the selected time period, e.g., as described above.

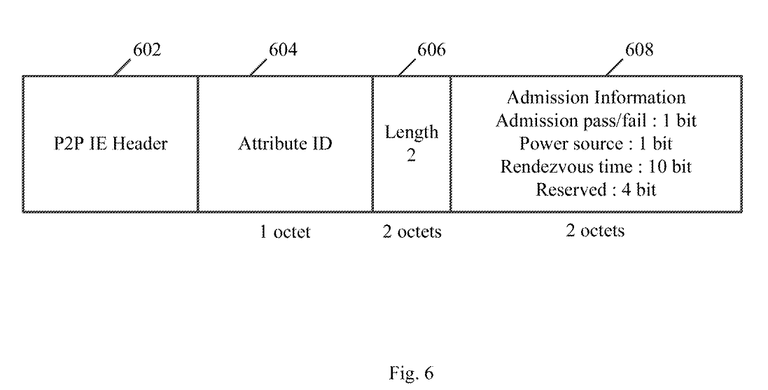

Reference is made to FIG. 6, which schematically illustrates an information element (IE) 600, in accordance with some demonstrative embodiments.

In some demonstrative embodiments, device 102 (FIG. 1) may send a first message including IE 600, for example, to device 140 (FIG. 1), e.g., as described above.

In some demonstrative embodiments, device 140 (FIG. 1) may send a second message including IE 600, for example, to device 102 (FIG. 1), e.g., as described above.

In some demonstrative embodiments, as shown in FIG. 6, IE 600 may include an admission information field 608, e.g., as described below. As shown in FIG. 6, IE 600 may also include an IE header field 602, an attribute ID field 604, e.g., having a length of 1 octet, and/or a length field 606, e.g., having a length of 2 octets.

In some demonstrative embodiments, admission information field 608 may have, for example, a size of 2 octets, or any other size.

In some demonstrative embodiments, admission information field 608 may include an admission pass/fail field, e.g., having a size of one bit or any other size, to indicate whether or not an admission control procedure to establish the session is successful at a sender of the IE 600, e.g., as described above.

In some demonstrative embodiments, admission information field 608 may include a power source field, e.g., having a size of one bit or any other size, to indicate a type of a power source of a sender of IE 600, e.g., as described above.

In some demonstrative embodiments, admission information field 608 may include a rendezvous time field, e.g., having a size of ten bits any other size, to indicate a preferred time period, for example, in seconds or any other time unit, of a sender of IE 600 to wait prior to attempting to establish a session with a receiver of the IE 600, e.g., as described above.

In some demonstrative embodiments, admission information field 608 may include one or more reserved bits, e.g., 4 bits or any other number of bits.

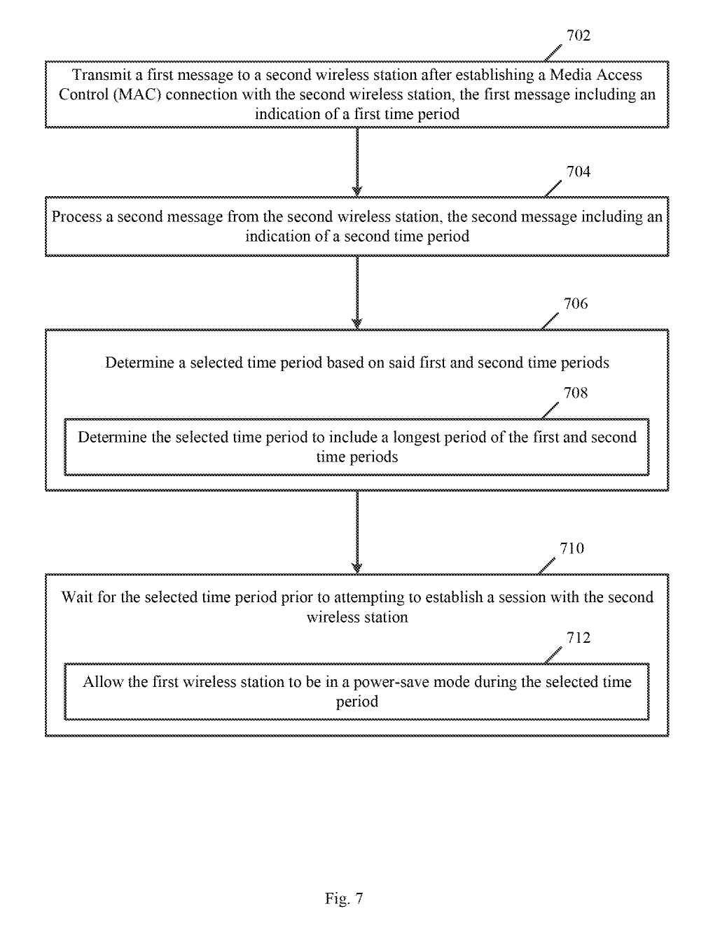

Reference is made to FIG. 7, which schematically illustrates a method of establishing a session, in accordance with some demonstrative embodiments. For example, one or more of the operations of FIG. 7 may be performed by one or more elements of a system, e.g., system 100 (FIG. 1); a device, e.g., wireless communication devices 102 and/or 140 (FIG. 1); a controller, e.g., controller 124 (FIG. 1), and/or controller 154 (FIG. 1); a radio, e.g., radio 114 (FIG. 1), and/or radio 144 (FIG. 1); and/or a message processor, e.g., message processor 128 (FIG. 1) and/or message processor 158 (FIG. 1).

As indicated at block 702, the method may include transmitting a first message to a second wireless station after establishing a MAC connection with the second wireless station, the first message including an indication of a first time period. For example, controller 124 (FIG. 1) may control, cause and/or trigger device 102 (FIG. 1) to send the first message, e.g., including IE 600 (FIG. 6), including the first time period to device 140 (FIG. 1), e.g., as described above.

As indicated at block 704, the method may include processing a second message from the second wireless station, the second message including an indication of a second time period. For example, controller 124 (FIG. 1) may control, cause and/or trigger device 102 (FIG. 1) to process the second message, e.g., including IE 600 (FIG. 6), including the second time period from device 140 (FIG. 1), e.g., as described above.

As indicated at block 706, the method may include determining a selected time period based on the first and second time periods. For example, controller 124 (FIG. 1) may control, cause and/or trigger device 102 (FIG. 1) to determine the selected time period based on the first and second time periods, e.g., as described above.

As indicated at block 708, determining the selected time period may include determining the selected time period to include a longest of the first and second time periods. For example, controller 124 (FIG. 1) may control, cause and/or trigger device 102 (FIG. 1) to determine the selected time period based on the longest of the first and second time periods, e.g., as described above.

As indicated at block 710, the method may include waiting for the selected time period prior to attempting to establish a session with the second wireless station. For example, controller 124 (FIG. 1) may control, cause and/or trigger device 102 (FIG. 1) to wait for the selected time period prior to attempting to establish a session with device 140 (FIG. 1), e.g., as described above.

As indicated at block 712, waiting for the selected time period may include allowing the first wireless station to be in a power-save mode during the selected time period. For example, controller 124 (FIG. 1) may allow device 102 (FIG. 1) to be in the power-save mode during the selected time period, e.g., as described above.

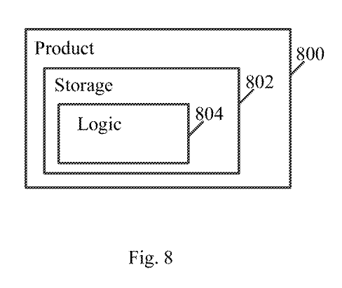

Reference is made to FIG. 8, which schematically illustrates a product of manufacture 800, in accordance with some demonstrative embodiments. Product 800 may include one or more tangible computer-readable non-transitory storage media 802, which may include computer-executable instructions, e.g., implemented by logic 804, operable to, when executed by at least one computer processor, enable the at least one computer processor to implement one or more operations at devices 102 and/or 140 (FIG. 1), radio 114 (FIG. 1), transmitter 118 (FIG. 1), receiver 116 (FIG. 1), controller 124, controller 154 (FIG. 1), radio 144 (FIG. 1), transmitter 148 (FIG. 1), receiver 146 (FIG. 1), message processor 128 (FIG. 1), and/or message processor 158 (FIG. 1), and/or to perform, trigger and/or implement one or more operations and/or functionalities described above with respect to of FIGS. 1, 2, 3, 4, 5, 6 and/or 7 and/or one or more operations described herein. The phrase “non-transitory machine-readable medium” is directed to include all computer-readable media, with the sole exception being a transitory propagating signal.

In some demonstrative embodiments, product 800 and/or machine-readable storage medium 802 may include one or more types of computer-readable storage media capable of storing data, including volatile memory, non-volatile memory, removable or non-removable memory, erasable or non-erasable memory, writeable or re-writeable memory, and the like. For example, machine-readable storage medium 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### EXAMPLES

The following examples pertain to further embodiments.

Example 1 includes an apparatus comprising circuitry and logic configured to cause a first wireless station to transmit a first message to a second wireless station after establishing a Media Access Control (MAC) connection with the second wireless station, the first message comprising an indication of a first time period; process a second message from the second wireless station, the second message comprising an indication of a second time period; determine a selected time period based on the first and second time periods; and wait for the selected time period prior to attempting to establish a session with the second wireless station.

Example 2 includes the subject matter of Example 1, and optionally, wherein the apparatus is configured to cause the first wireless station to determine the selected time period to include a longest period of the first and second time periods.

Example 3 includes the subject matter of Example 1 or 2, and optionally, wherein the apparatus is configured to allow the first wireless station to be in a power-save mode during the selected time period.

Example 4 includes the subject matter of any one of Examples 1-3, and optionally, wherein the apparatus is configured to cause the first wireless station to determine the selected time period to include the second time period, if the first wireless station is powered by a mains power source.

Example 5 includes the subject matter of Example 4, and optionally, wherein the apparatus is configured to cause the first wireless station to remain at an active power mode during the selected time period.

Example 6 includes the subject matter of any one of Examples 1-3, and optionally, wherein the apparatus is configured to cause the first wireless station to determine the selected time period to include the first time period, if the second message indicates the second wireless station is powered by a mains power source.

Example 7 includes the subject matter of any one of Examples 1-6, and optionally, wherein the first message comprises an information element (IE) comprising a power field and a time field, the power field to indicate a power source of the first wireless station, and the time field comprising the indication of the first time period.

Example 8 includes the subject matter of Example 7, and optionally, wherein the power field is to indicate if the first wireless station is battery powered or powered by a mains power source.

Example 9 includes the subject matter of Example 7, and optionally, wherein the IE comprises an admission field configured to indicate whether or not an admission control procedure to establish the session is successful.

Example 10 includes the subject matter of any one of Examples 1-9, and optionally, wherein the second message comprises an information element (IE) comprising a power field and a time field, the power field to indicate a power source of the second wireless station, and the time field comprising the indication of the second time period.

Example 11 includes the subject matter of any one of Examples 1-10, and optionally, wherein the apparatus is configured to cause the first wireless station to transmit the first message upon failure of an attempt to establish the session with the second wireless station.

Example 12 includes the subject matter of Example 11, and optionally, wherein the first message comprises an information element (IE) comprising an admission field configured to indicate whether or not an admission control procedure to establish the session is successful.

Example 13 includes the subject matter of any one of Examples 1-12, and optionally, wherein the apparatus is configured to cause the first wireless station to attempt to establish the session with the second wireless station by performing an admission control procedure to determine if a link capacity of a wireless link between the first and second wireless stations is greater than a predefined threshold.

Example 14 includes the subject matter of any one of Examples 1-13, and optionally, wherein the apparatus is configured to transmit to the second wireless station an acknowledge (Ack) message to confirm receipt of the second message.

Example 15 includes the subject matter of any one of Examples 1-14, and optionally, wherein the first and second messages comprise Peer-to-Peer (P2P) messages.

Example 16 includes the subject matter of Example 15, and optionally, wherein the first and second messages comprise an information request and an information response, an association request and an association response, or a re-association request and a re-association response.

Example 17 includes the subject matter of any one of Examples 1-16, and optionally, comprising a radio to transmit the first message, and to receive the second message.

Example 18 includes the subject matter of any one of Examples 1-17, and optionally, comprising one or more antennas, a memory and a processor.

Example 19 includes a system of wireless communication comprising a first wireless station, the first wireless station comprising one or more antennas; a memory; a radio; and a controller configured to cause the first wireless station to transmit a first message to a second wireless station after establishing a Media Access Control (MAC) connection with the second wireless station, the first message comprising an indication of a first time period; process a second message from the second wireless station, the second message comprising an indication of a second time period; determine a selected time period based on the first and second time periods; and wait for the selected time period prior to attempting to establish a session with the second wireless station.

Example 20 includes the subject matter of Example 19, and optionally, wherein the first wireless station is to determine the selected time period to include a longest period of the first and second time periods.

Example 21 includes the subject matter of Example 19 or 20, and optionally, wherein the controller is to allow the first wireless station to be in a power-save mode during the selected time period.

Example 22 includes the subject matter of any one of Examples 19-21, and optionally, wherein the first wireless station is to determine the selected time period to include the second time period, if the first wireless station is powered by a mains power source.

Example 23 includes the subject matter of Example 22, and optionally, wherein the first wireless station is to remain at an active power mode during the selected time period.

Example 24 includes the subject matter of any one of Examples 19-21, and optionally, wherein the first wireless station is to determine the selected time period to include the first time period, if the second message indicates the second wireless station is powered by a mains power source.

Example 25 includes the subject matter of any one of Examples 19-24, and optionally, wherein the first message comprises an information element (IE) comprising a power field and a time field, the power field to indicate a power source of the first wireless station, and the time field comprising the indication of the first time period.

Example 26 includes the subject matter of Example 25, and optionally, wherein the power field is to indicate if the first wireless station is battery powered or powered by a mains power source.

Example 27 includes the subject matter of Example 25, and optionally, wherein the IE comprises an admission field configured to indicate whether or not an admission control procedure to establish the session is successful.

Example 28 includes the subject matter of any one of Examples 19-27, and optionally, wherein the second message comprises an information element (IE) comprising a power field and a time field, the power field to indicate a power source of the second wireless station, and the time field comprising the indication of the second time period.

Example 29 includes the subject matter of any one of Examples 19-28, and optionally, wherein the first wireless station is to transmit the first message upon failure of an attempt to establish the session with the second wireless station.

Example 30 includes the subject matter of Example 29, and optionally, wherein the first message comprises an information element (IE) comprising an admission field configured to indicate whether or not an admission control procedure to establish the session is successful.

Example 31 includes the subject matter of any one of Examples 19-30, and optionally, wherein the first wireless station is to attempt to establish the session with the second wireless station by performing an admission control procedure to determine if a link capacity of a wireless link between the first and second wireless stations is greater than a predefined threshold.

Example 32 includes the subject matter of any one of Examples 19-31, and optionally, wherein the first wireless station is to transmit to the second wireless station an acknowledge (Ack) message to confirm receipt of the second message.

Example 33 includes the subject matter of any one of Examples 19-32, and optionally, wherein the first and second messages comprise Peer-to-Peer (P2P) messages.

Example 34 includes the subject matter of Example 33, and optionally, wherein the first and second messages comprise an information request and an information response, an association request and an association response, or a re-association request and a re-association response.

Example 35 includes a method to be performed at a first wireless station, the method comprising transmitting a first message to a second wireless station after establishing a Media Access Control (MAC) connection with the second wireless station, the first message comprising an indication of a first time period; processing a second message from the second wireless station, the second message comprising an indication of a second time period; determining a selected time period based on the first and second time periods; and waiting for the selected time period prior to attempting to establish a session with the second wireless station.

Example 36 includes the subject matter of Example 35, and optionally, comprising determining the selected time period to include a longest period of the first and second time periods.

Example 37 includes the subject matter of Example 35 or 36, and optionally, comprising allowing the first wireless station to be in a power-save mode during the selected time period.

Example 38 includes the subject matter of any one of Examples 35-37, and optionally, comprising determining the selected time period to include the second time period, if the first wireless station is powered by a mains power source.

Example 39 includes the subject matter of Example 38, and optionally, comprising causing the first wireless station to remain at an active power mode during the selected time period.

Example 40 includes the subject matter of any one of Examples 35-37, and optionally, comprising determining the selected time period to include the first time period, if the second message indicates the second wireless station is powered by a mains power source.

Example 41 includes the subject matter of any one of Examples 35-40, and optionally, wherein the first message comprises an information element (IE) comprising a power field and a time field, the power field to indicate a power source of the first wireless station, and the time field comprising the indication of the first time period.

Example 42 includes the subject matter of Example 41, and optionally, wherein the power field is to indicate if the first wireless station is battery powered or powered by a mains power source.

Example 43 includes the subject matter of Example 41, and optionally, wherein the IE comprises an admission field configured to indicate whether or not an admission control procedure to establish the session is successful.

Example 44 includes the subject matter of any one of Examples 35-43, and optionally, wherein the second message comprises an information element (IE) comprising a power field and a time field, the power field to indicate a power source of the second wireless station, and the time field comprising the indication of the second time period.

Example 45 includes the subject matter of any one of Examples 35-44, and optionally, comprising transmitting the first message upon failure of an attempt to establish the session with the second wireless station.

Example 46 includes the subject matter of Example 45, and optionally, wherein the first message comprises an information element (IE) comprising an admission field configured to indicate whether or not an admission control procedure to establish the session is successful.

Example 47 includes the subject matter of any one of Examples 35-46, and optionally, comprising attempting to establish the session with the second wireless station by performing an admission control procedure to determine if a link capacity of a wireless link between the first and second wireless stations is greater than a predefined threshold.

Example 48 includes the subject matter of any one of Examples 35-47, and optionally, comprising transmitting to the second wireless station an acknowledge (Ack) message to confirm receipt of the second message.

Example 49 includes the subject matter of any one of Examples 35-48, and optionally, wherein the first and second messages comprise Peer-to-Peer (P2P) messages.

Example 50 includes the subject matter of Example 49, and optionally, wherein the first and second messages comprise an information request and an information response, an association request and an association response, or a re-association request and a re-association response.

Example 51 includes a product including one or more tangible computer-readable non-transitory storage media comprising computer-executable instructions operable to, when executed by at least one computer processor, enable the at least one computer processor to implement operations at a first wireless station, the operations comprising transmitting a first message to a second wireless station after establishing a Media Access Control (MAC) connection with the second wireless station, the first message comprising an indication of a first time period; processing a second message from the second wireless station, the second message comprising an indication of a second time period; determining a selected time period based on the first and second time periods; and waiting for the selected time period prior to attempting to establish a session with the second wireless station.

Example 52 includes the subject matter of Example 51, and optionally, wherein the operations comprise determining the selected time period to include a longest period of the first and second time periods.

Example 53 includes the subject matter of Example 51 or 52, and optionally, wherein the operations comprise allowing the first wireless station to be in a power-save mode during the selected time period.

Example 54 includes the subject matter of any one of Examples 51-53, and optionally, wherein the operations comprise determining the selected time period to include the second time period, if the first wireless station is powered by a mains power source.

Example 55 includes the subject matter of Example 54, and optionally, wherein the operations comprise causing the first wireless station to remain at an active power mode during the selected time period.

Example 56 includes the subject matter of any one of Examples 51-53, and optionally, wherein the operations comprise determining the selected time period to include the first time period, if the second message indicates the second wireless station is powered by a mains power source.

Example 57 includes the subject matter of any one of Examples 51-56, and optionally, wherein the first message comprises an information element (IE) comprising a power field and a time field, the power field to indicate a power source of the first wireless station, and the time field comprising the indication of the first time period.

Example 58 includes the subject matter of Example 57, and optionally, wherein the power field is to indicate if the first wireless station is battery powered or powered by a mains power source.

Example 59 includes the subject matter of Example 57, and optionally, wherein the IE comprises an admission field configured to indicate whether or not an admission control procedure to establish the session is successful.

Example 60 includes the subject matter of any one of Examples 51-59, and optionally, wherein the second message comprises an information element (IE) comprising a power field and a time field, the power field to indicate a power source of the second wireless station, and the time field comprising the indication of the second time period.

Example 61 includes the subject matter of any one of Examples 51-60, and optionally, wherein the operations comprise transmitting the first message upon failure of an attempt to establish the session with the second wireless station.

Example 62 includes the subject matter of Example 61, and optionally, wherein the first message comprises an information element (IE) comprising an admission field configured to indicate whether or not an admission control procedure to establish the session is successful.

Example 63 includes the subject matter of any one of Examples 51-62, and optionally, wherein the operations comprise attempting to establish the session with the second wireless station by performing an admission control procedure to determine if a link capacity of a wireless link between the first and second wireless stations is greater than a predefined threshold.

Example 64 includes the subject matter of any one of Examples 51-63, and optionally, wherein the operations comprise transmitting to the second wireless station an acknowledge (Ack) message to confirm receipt of the second message.

Example 65 includes the subject matter of any one of Examples 51-64, and optionally, wherein the first and second messages comprise Peer-to-Peer (P2P) messages.

Example 66 includes the subject matter of Example 65, and optionally, wherein the first and second messages comprise an information request and an information response, an association request and an association response, or a re-association request and a re-association response.

Example 67 includes an apparatus of wireless communication by a first wireless station, the apparatus comprising means for transmitting a first message to a second wireless station after establishing a Media Access Control (MAC) connection with the second wireless station, the first message comprising an indication of a first time period; means for processing a second message from the second wireless station, the second message comprising an indication of a second time period; means for determining a selected time period based on the first and second time periods; and means for waiting for the selected time period prior to attempting to establish a session with the second wireless station.

Example 68 includes the subject matter of Example 67, and optionally, comprising means for determining the selected time period to include a longest period of the first and second time periods.

Example 69 includes the subject matter of Example 67 or 68, and optionally, comprising means for allowing the first wireless station to be in a power-save mode during the selected time period.

Example 70 includes the subject matter of any one of Examples 67-69, and optionally, comprising means for determining the selected time period to include the second time period, if the first wireless station is powered by a mains power source.

Example 71 includes the subject matter of Example 70, and optionally, comprising means for causing the first wireless station to remain at an active power mode during the selected time period.

Example 72 includes the subject matter of any one of Examples 67-69, and optionally, comprising means for determining the selected time period to include the first time period, if the second message indicates the second wireless station is powered by a mains power source.

Example 73 includes the subject matter of any one of Examples 67-72, and optionally, wherein the first message comprises an information element (IE) comprising a power field and a time field, the power field to indicate a power source of the first wireless station, and the time field comprising the indication of the first time period.

Example 74 includes the subject matter of Example 73, and optionally, wherein the power field is to indicate if the first wireless station is battery powered or powered by a mains power source.

Example 75 includes the subject matter of Example 73, and optionally, wherein the IE comprises an admission field configured to indicate whether or not an admission control procedure to establish the session is successful.

Example 76 includes the subject matter of any one of Examples 67-75, and optionally, wherein the second message comprises an information element (IE) comprising a power field and a time field, the power field to indicate a power source of the second wireless station, and the time field comprising the indication of the second time period.

Example 77 includes the subject matter of any one of Examples 67-76, and optionally, comprising means for transmitting the first message upon failure of an attempt to establish the session with the second wireless station.

Example 78 includes the subject matter of Example 77, and optionally, wherein the first message comprises an information element (IE) comprising an admission field configured to indicate whether or not an admission control procedure to establish the session is successful.

Example 79 includes the subject matter of any one of Examples 67-78, and optionally, comprising means for attempting to establish the session with the second wireless station by performing an admission control procedure to determine if a link capacity of a wireless link between the first and second wireless stations is greater than a predefined threshold.

Example 80 includes the subject matter of any one of Examples 67-79, and optionally, comprising means for transmitting to the second wireless station an acknowledge (Ack) message to confirm receipt of the second message.

Example 81 includes the subject matter of any one of Examples 67-80, and optionally, wherein the first and second messages comprise Peer-to-Peer (P2P) messages.

Example 82 includes the subject matter of Example 81, and optionally, wherein the first and second messages comprise an information request and an information response, an association request and an association response, or a re-association request and a re-association response.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising circuitry and logic configured to cause a first wireless station to:
transmit a first message to a second wireless station after establishing a Media Access Control (MAC) connection with the second wireless station, the first message comprising an indication of a first time period;
process a second message from the second wireless station, the second message comprising an indication of a second time period;
determine a selected time period based on the first and second time periods; and
wait for the selected time period prior to attempting to establish a session with the second wireless station.

2. The apparatus of claim 1 configured to cause the first wireless station to determine the selected time period to include a longest period of the first and second time periods.

3. The apparatus of claim 1 configured to allow the first wireless station to be in a power-save mode during the selected time period.

4. The apparatus of claim 1 configured to cause the first wireless station to determine the selected time period to include the second time period, if the first wireless station is powered by a mains power source.

5. The apparatus of claim 4 configured to cause the first wireless station to remain at an active power mode during the selected time period.

6. The apparatus of claim 1 configured to cause the first wireless station to determine the selected time period to include the first time period, if the second message indicates the second wireless station is powered by a mains power source.

7. The apparatus of claim 1, wherein the first message comprises an information element (IE) comprising a power field and a time field, the power field to indicate a power source of the first wireless station, and the time field comprising the indication of the first time period.

8. The apparatus of claim 7, wherein the power field is to indicate if the first wireless station is battery powered or powered by a mains power source.

9. The apparatus of claim 7, wherein the IE comprises an admission field configured to indicate whether or not an admission control procedure to establish the session is successful.

10. The apparatus of claim 1, wherein the second message comprises an information element (IE) comprising a power field and a time field, the power field to indicate a power source of the second wireless station, and the time field comprising the indication of the second time period.

11. The apparatus of claim 1 configured to cause the first wireless station to transmit the first message upon failure of an attempt to establish the session with the second wireless station.

12. The apparatus of claim 11, wherein the first message comprises an information element (IE) comprising an admission field configured to indicate whether or not an admission control procedure to establish the session is successful.

13. The apparatus of claim 1 configured to cause the first wireless station to attempt to establish the session with the second wireless station by performing an admission control procedure to determine if a link capacity of a wireless link between the first and second wireless stations is greater than a predefined threshold.

14. The apparatus of claim 1 configured to transmit to the second wireless station an acknowledge (Ack) message to confirm receipt of the second message.

15. The apparatus of claim 1, wherein the first and second messages comprise Peer-to-Peer (P2P) messages.

16. The apparatus of claim 15, wherein the first and second messages comprise an information request and an information response, an association request and an association response, or a re-association request and a re-association response.

17. The apparatus of claim 1 comprising a radio to transmit the first message, and to receive the second message.

18. The apparatus of claim 1 comprising one or more antennas, a memory and a processor.

19. A method to be performed at a first wireless station, the method comprising:
transmitting a first message to a second wireless station after establishing a Media Access Control (MAC) connection with the second wireless station, the first message comprising an indication of a first time period;
processing a second message from the second wireless station, the second message comprising an indication of a second time period;
determining a selected time period based on the first and second time periods; and
waiting for the selected time period prior to attempting to establish a session with the second wireless station.

20. The method of claim 19, wherein the first message comprises an information element (IE) comprising a power field and a time field, the power field to indicate a power source of the first wireless station, and the time field comprising the indication of the first time period.

21. A product including one or more tangible computer-readable non-transitory storage media comprising computer-executable instructions operable to, when executed by at least one computer processor, enable the at least one computer processor to implement operations at a first wireless station, the operations comprising:
transmitting a first message to a second wireless station after establishing a Media Access Control (MAC) connection with the second wireless station, the first message comprising an indication of a first time period;
processing a second message from the second wireless station, the second message comprising an indication of a second time period;
determining a selected time period based on the first and second time periods; and
waiting for the selected time period prior to attempting to establish a session with the second wireless station.

22. The product of claim 21, wherein the operations comprise determining the selected time period to include a longest period of the first and second time periods.

23. The product of claim 21, wherein the operations comprise determining the selected time period to include the second time period, if the first wireless station is powered by a mains power source.

24. The product of claim 21, wherein the first message comprises an information element (IE) comprising a power field and a time field, the power field to indicate a power source of the first wireless station, and the time field comprising the indication of the first time period.

25. The product of claim 21, wherein the operations comprise attempting to establish the session with the second wireless station by performing an admission control procedure to determine if a link capacity of a wireless link between the first and second wireless stations is greater than a predefined threshold.
